(19) United States
(12) Patent Application Publication
(10) Pub. No.: US 2013/0205921 A1
(43) Pub. Date: Aug. 15, 2013

(54) Device for Collection of Materials from Surfaces

(71) Applicants: Andre Venter, Kalamazoo, MI (US); Afrand Kamali, East Lansing, MI (US)

(72) Inventors: Andre Venter, Kalamazoo, MI (US); Afrand Kamali, East Lansing, MI (US)

(73) Assignee: WESTERN MICHIGAN UNIVERSITY RESEARCH FOUNDATION, Kalamazoo, MI (US)

(21) Appl. No.: 13/703,110

(22) PCT Filed: Jun. 10, 2011
(86) PCT No.: PCT/US2011/039930

§ 371 Date: Feb. 18, 2013

Related U.S. Application Data
(60) Provisional application No. 61/353,491, filed on Jun. 10, 2010.

(51) Int. Cl. G01N 1/02

(52) U.S. Cl. CPC G01N 1/02
USPC 73/864

(57) ABSTRACT

A device for collecting material from a solid surface, and optionally concentrating the collected material, for subsequent analysis includes a nebulizer that generates and discharges a fluid stream, and a collector positioned to intercept material caused by the fluid stream after it is deflected from the solid surface. The device is usable in a sample collection process having steps of spraying a fluid stream of gas containing nebulized solvent as the solid surface, positioning a collector to intercept material carried by the fluid. The process may be repeated to concentrate the material being sampled.

### CROSS-REFERENCE TO RELATED APPLICATION

This application claims priority under 35 U.S.C. §119(e) to U.S. Provisional Application No. 61/353,491, entitled DEVICE FOR COLLECTION OF MATERIALS FROM SURFACES, filed Jun. 10, 2010, the entire disclosure of which is incorporated herein by reference.

### FIELD OF THE INVENTION

This invention relates to the field of sample collection for analysis and/or detection of an analyte, and more particularly, to a process and device for collecting a material from a solid surface and concentrating the material for subsequent detection and/or analysis.

### BACKGROUND OF THE INVENTION

Conventional swab-wiping and solvent washing techniques are often cumbersome when the material being sampled is present in a very small quantity distributed over a large surface area. Sometimes it is impossible to collect and concentrate a sufficient amount of material for analysis and/or detection of an analyte. Occasionally, it is difficult to recover analytes from a swab.

### SUMMARY OF THE INVENTION

The invention provides a new and improved process and apparatus for collecting and concentrating material distributed on a surface. The new process and apparatus has advantages over conventional methods and apparatus, such as the ability to pre-concentrate compounds that are present at low abundance across large surface areas, and/or collect chemical compounds from surfaces where conventional swabbing fails.

A process for collecting a sample of a material distributed over a solid surface in accordance with certain embodiments of the invention involves spraying a fluid stream of inert gas containing a nebulized solvent at a solid surface on which a material is distributed to cause desorption of the material from the solid surface and entrainment of the material by the fluid stream, and positioning a collector surface to intercept the desorbed material carried by the fluid stream deflected from the solid surface. Optionally, the apparatus may be moved around over a large surface area to repeat the spraying and positioning steps for one or more different areas of the solid surface to concentrate material on the collector surface.

A process for collecting a sample of material distributed on a solid surface and analyzing the material in accordance with certain embodiments of this invention involves spraying a fluid stream of an inert gas containing a nebulized solvent and positioning a collector surface to intercept the desorbed material carried by the fluid stream as described above, and further steps of removing the material from the collector surface, and/or employing a conventional analytical technique to detect, identify, and/or quantify the material.

An apparatus for collecting a sample of a material distributed over a solid surface includes a nebulizer that generates and discharges a fluid stream comprising a gas and a solvent dispersed in the gas in the form of liquid particles, and a collector positioned to intercept desorbed material carried by a fluid stream discharged from the nebulizer and deflected from a solid surface at which the stream from the nebulizer is directed.

These and other features, advantages and objects of the present invention will be further understood and appreciated by those skilled in the art by reference to the following specification, claims and appended drawings.

### BRIEF DESCRIPTION OF THE DRAWINGS

FIG. 1 shows an apparatus in accordance with certain aspects of the invention being used to collect a material from a solid surface.

FIG. 2 shows components used in the apparatus shown in FIG. 1.

### DESCRIPTION OF THE PREFERRED EMBODIMENTS

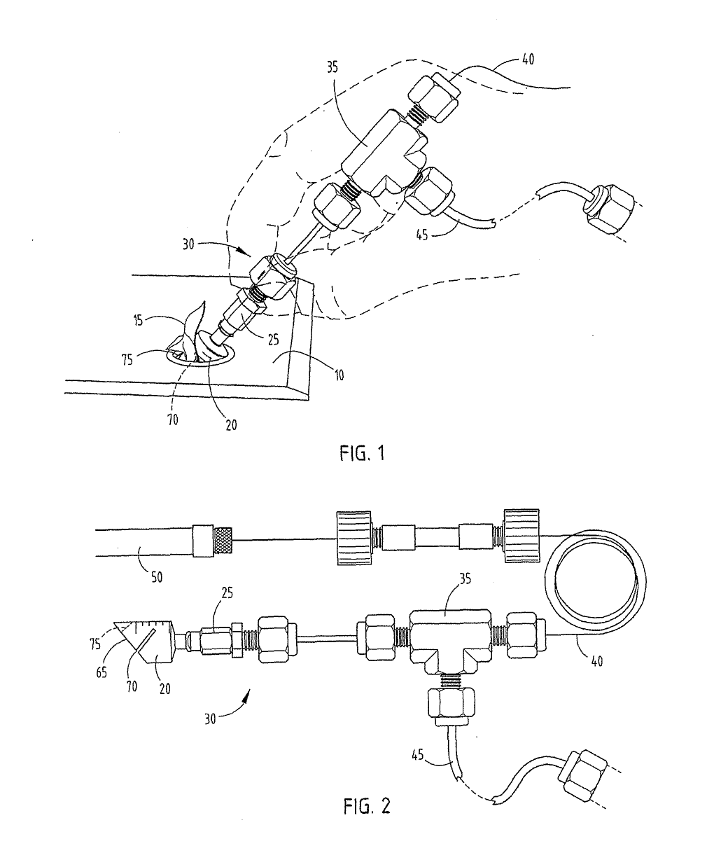

A process and apparatus for collecting a sample of a material distributed over a solid surface 10 in accordance with certain aspects of this invention is illustrated in FIG. 1. The process generally comprises steps of spraying a fluid stream of gas containing a nebulized solvent at a solid surface 10 on which a material is distributed to cause removal (including desorption) of the material from the solid surface and entrainment of the material by the fluid stream. At the same time, a collector 15 having a collector surface is positioned to intercept the desorbed material carried by the fluid stream deflected from the solid surface. Optionally, and desirably, the apparatus for spraying a fluid stream of inert gas containing a nebulized solvent and the positioned collector surface to intercept the desorbed material carried by the fluid stream deflected from the solid surface is repositioned at a different area of the solid surface to concentrate material on the collector surface. This can be repeated as desired or necessary to further concentrate material on the collector surface.

Examples of materials that can be collected, concentrated and analyzed using the processes and apparatus of this invention include generally any substance that is soluble in the nebulized solvent and which is capable of being absorbed by or adsorbed on a solid surface.

The gas that can be used in accordance with the processes and apparatuses of this invention may generally comprise any gas that will not react undesirably with the material being collected for analysis, and which is not otherwise hazardous or undesirable. Preferred gases include nitrogen and compressed air.

Suitable solvents that may be employed in the invention generally include any liquid that is capable of dissolving the substance that is to be collected and analyzed. Examples include various hydrocarbon solvents such as pentane, cyclopentane, hexane, cyclohexane, benzene, and toluene; halogenated hydrocarbons such as chloroform and dichloromethane; and various heterogeneous compounds such as 1,4-dioxane, diethyl ether, tetrahydrofuran, ethyl acetate, acetone, dimethyloformamide, acetonitrile, dimethylsulfoxide, formic acid, n-butanol, isopropanol, n-propanol, ethanol, methanol, acetic acid; water; and mixtures of these solvents.

Reactants may in some cases be added to the solvent or gas stream to aid in the desorption or collection of desired compounds from the solid surface 10 onto the collection surface. The collection surface may be made reactive to selectively collect specific substances.

Nebulizers that may be employed in accordance with this invention are well known and commercially available. Such devices are capable of dispersing liquid solvent in a stream of fast moving gas in the form of discrete liquid particles having a size on the order from several microns to less than one micron.

In accordance with preferred aspects of the invention, as illustrated in FIG. 1, an apparatus in accordance with the invention may comprise an enclosure and holder 20 that maintains the nozzle 25 of the nebulizer and collector 15 in a desired predetermined orientation. In the illustrated embodiment, the stream of inert gas and nebulized solvent dispersed in the inert gas is directed at surface 10 from which a sample of material is being collected so that the stream impinges surface 10 at an angle of about 30° to 90°, and is deflected upwardly away from solid surface 10 and upwardly toward the surface of collector 15. The deflection angle (i.e., the smaller angle (i.e., acute angle) between the solid surface and the deflected stream) is low (0° to 10° is typical), with the collector surface being arranged at about a 90° angle from the solid surface 10 so that the deflected stream impinges upon the collector surface at approximately a right angle (e.g., about 90°).

Conventional solvent extraction or other techniques may be used for removing the collected material from the collector surface for subsequent analysis. Alternatively, collector 15 may be an appropriate device for inserting material to be analyzed into an analysis detection device (e.g. a MALDI plate for mass spectrometry or a glass cuvette for UV analysis). Suitable analysis/detection techniques include mass spectroscopy, infrared spectroscopy, chromatography, and various other conventional analytical and chemical detection techniques.

The illustrated microsprayer 30 of FIG. 2 is constructed from a Swagelok T-piece 35 connected to a fused silica solvent line 40 and to a pressurized nebulizing gas supply line 45. High purity nitrogen gas or air may be employed. A glass syringe 50 and a syringe pump (not shown) supply solvent. A typical optimized gas pressure and solvent flow rate combination is 250 psi nitrogen and 60 μL/min solvent. The solvent composition is chosen based on the solubility of the chemical compounds that are to be collected. Various solvents such as isopropanol, methanol-water mixtures, hexane, dichloromethane, etc. have been used. Microsprayer 30 is connected through a luer lock 55 to enclosure/collector holder 20. An enclosed sample space is defined by enclosure/collector holder 20 and solid surface 10. Enclosure/collector holder 20 has an angled forward edge 65 for contacting solid surface 10. A 45° angle is typical. A slit 70 through enclosure/collector holder 20 allows a collector 15 to be inserted into the enclosure and to be held during sample collection. Collector 15 can be a continuous solid material or a mesh material. Suitable collector materials include paper, polypropylene, nylon, and polytetrafluoroethylene (Teflon). An aperture 75 can be provided behind the collection surface of collector 15 to allow nebulizing gas to escape. The position of aperture 75 is selected to prevent pressure from increasing within the enclosure without interfering with the spray.

The method allows large area surface analysis of in-situ field samples without the need for portable analytical equipment. A handheld and portable spray and collection device in accordance with certain embodiments of the invention allows convenient and efficient collection of surface materials from a variety of solid surfaces for analysis by various analytical techniques.

Potential applications for the invention are not limited to, but include, research areas such as: environmental monitoring, occupational health issues relating to the manufacture of nanomaterials, forensic science, remediation monitoring for methamphetamine drug manufacturing sites, and pharmaceutical cleaning validation.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A process for collecting a sample of a material distributed over a solid surface comprising:
spraying a fluid stream of a gas containing a nebulized solvent at a solid surface on which a material is distributed to cause removal of the material from the solid surface and entrainment of the material by the fluid stream;
positioning a collector surface to intercept the material entrained b y the fluid stream deflected from the solid surface; and
optionally repeating the spraying and positioning steps for one or more different areas of the solid surface to concentrate material on the collector surface.

2. A process for collecting a sample of a material distributed over a solid surface and analyzing the material, comprising:
spraying a fluid stream of a gas containing a nebulized solvent at a solid surface area on which a material is distributed to cause desorption of the material from the solid surface and entrainment of the material by the fluid stream;
positioning a collector surface to intercept the desorbed material carried by the fluid stream deflected from the solid surface;
optionally repeating the spraying and positioning steps for one or more different areas of the solid surface to concentrate material on the collector surface;
removing the material from the collector surface; and
employing a conventional analytical technique to detect, identify and/or quantify the material.

3. An apparatus for collecting a sample of a material distributed over a solid surface comprising:
a nebulizer that generates and discharges a fluid stream comprising an inert gas and a solvent dispersed in the inert gas in the form of liquid particles; and
a collector positioned to intercept material carried by the fluid stream deflected from the solid surface.

4. The apparatus of claim 3, in which the nebulizer and the collector surface are maintained in a predetermined orientation suitable for collecting a sample by a holder member.
